(19) United States
(12) Patent Application Publication
(10) Pub. No.: US 2012/0139981 A1
(43) Pub. Date: Jun. 7, 2012

(54) Thermal Inkjet Printhead And Method

(76) Inventors: Sterling Chaffins, Albany, OR (US); Bradley D. Chung, Corvallis, OR (US); Paul Joseph Bruinsma, San Diego, CA (US); Satya Prakash, San Diego, CA (US); Kevin P. DeKam, Albany, OR (US)

(21) Appl. No.: 12/957,732

(22) Filed: Dec. 1, 2010

(51) Int. Cl. B41J 29/38

(52) U.S. Cl. 347/11

(57) ABSTRACT

Methods of controllably ejecting liquid from a thermal inkjet printhead. A first pulse set sufficient to form a bubble to eject a drop of a liquid having a polymer phase dispersed in a colloidal suspension is applied to a firing resistor. The first pulse set forms a polymer residue on the firing resistor. After the first pulse set and before a collapse of the bubble, a second pulse insufficient to eject a drop of the liquid is applied to the firing resistor. The second pulse facilitates removal of at least a portion of the residue from the firing resistor.

### BACKGROUND

Thermal inkjet printheads are commonly used to controllably eject drops of liquids to form desired patterns, which may include text, graphics, or photographic images, on print media. However, certain types of liquids, while advantageous in terms of the appearance and durability of the printed output that result, may be difficult for thermal inkjet printheads to eject reliably over time. For example, certain latex and polyurethane inks can quickly degrade performance of a thermal inkjet printhead to the degree that the printed output does not portray the desired pattern with adequate image quality. Thus the printhead is frequently replaced, at considerable cost, when used to eject such liquids.

### BRIEF DESCRIPTION OF THE DRAWINGS

FIG. 1 is a schematic cross-sectional view of a liquid ejection element of an example thermal inkjet printhead in accordance with an embodiment of the present disclosure.

FIG. 2 is a schematic block diagram of a printer including a thermal inkjet printhead having the liquid ejection element of FIG. 1 and a controller that generates electrical pulses to the liquid ejection element, in accordance with an embodiment of the present disclosure.

FIGS. 3A through 3C are schematic representations of phases of the ejection of a drop of liquid from the liquid ejection element of FIG. 1, in accordance with an embodiment of the present disclosure.

FIG. 4 is a schematic representation of bubble volume and temperature at the liquid-to-firing resistor interface in response to the application of an ejection pulse to the firing resistor of the liquid ejection element of FIG. 1, in accordance with an embodiment of the present disclosure.

FIG. 5 is a flowchart of a method of controllably ejecting liquid from a thermal inkjet printhead, in accordance with an embodiment of the present disclosure.

FIG. 6 is a flowchart of another method of controllably ejecting liquid from a thermal inkjet printhead, in accordance with an embodiment of the present disclosure.

FIGS. 7A and 7B are schematic representations of bubble volume and temperature at the liquid-to-firing resistor interface in response to the application of an ejection pulse and a subsequent non-ejection pulse to the firing resistor of the liquid ejection element of FIG. 1, in accordance with embodiments of the present disclosure.

FIG. 8 is a schematic depiction of an example surface condition of a clean firing resistor of the liquid ejection element of FIG. 1; an example surface condition of the firing resistor of the liquid ejection element of FIG. 1 following one or more drop ejections generated using ejection pulses but not subsequent non-ejection pulses; and an example surface condition of the firing resistor of the liquid ejection element of FIG. 1 following one or more drop ejections generated using ejection pulses and subsequent non-ejection pulses, in accordance with an embodiment of the present disclosure.

### DETAILED DESCRIPTION

Referring now to the drawings, there is illustrated an embodiment of a printer, a thermal inkjet printhead, and embodiments of methods for controllably ejecting liquid from the printhead that enable liquids such as, for example, certain latex and polyurethane inks, to be reliably ejected to form high quality printed output. As defined herein and in the appended claims, a “liquid” shall be broadly understood to mean a fluid not composed primarily of a gas or gases. The firing resistor of a liquid ejection element of the printhead is first heated to eject a drop of the liquid, the ejection possibly causing degradation of a surface of the firing resistor which would adversely affect one or more characteristics of subsequently ejected drops. The degradation may include solidification of a residue on the surface of the resistor. Then the resistor is heated without ejecting a drop to recondition the resistor, in order to mitigate these adverse effects on subsequently ejected drops and thus maintain the desired drop characteristics on the subsequently ejected drops. The reconditioning may include facilitating the removal of residue from the resistor surface.

Thermal inkjet printheads are at the heart of a wide variety of printing devices. Such devices include inkjet printers, copiers, facsimile machines, and all-in-one devices (e.g. a combination of at least two of a printer, scanner, copier, and fax), to name a few. Such devices also include commercial presses, web presses, and large-format devices such as sign printers. The print medium may be any type of suitable sheet or roll material, such as paper, card stock, cloth or other fabric, transparencies, mylar, and the like.

In some printing applications, high durability of the printed output is desired. In such applications, the use of latex and polyurethane inks can be advantageous. These inks include a polymer phase in a solvent, which may be water, for example, or which may include water along with other cosolvents. In some polymeric inks, the polymer phase may be dissolved in the solvent, while in some other polymeric inks, the polymer phase may be dispersed in the solvent, forming a colloidal suspension of particles, with diameters typically between, for example 50 nanometers and 500 nanometers that are kept in solution by colloidal forces. Inks with a dispersed polymer phase typically have a viscosity more suitable for ejection from thermal inkjet printheads than inks with a dissolved polymer phase.

In addition, the polymer phases in different inks may have different glass transition temperatures (Tg). Tg is the temperature at which the polymer chains can start sliding by each other for mobility. After printing, in order to fuse the polymer particles on the print medium to obtain high durability printed output, the medium is heated above Tg. However, the heat used to fuse higher Tg inks can damage certain types of print media, rendering the inks unsuitable for these media types. Also, higher temperature post-heating zones are more expensive and have higher operating costs. Thus it may be advantageous to print with polymeric inks having lower values of Tg. For example, it may be advantageous to print with inks having a Tg of 70 degrees C. or less. Furthermore, polymeric inks with a dispersed polymer phase and having lower values of Tg are typically available as standard commercial products rather than specialty engineered ones, and as a result are generally less expensive than other polymeric inks suitable for thermal jetting. Use of such standard commercial polymers advantageously lowers the cost of operation of the printing system.

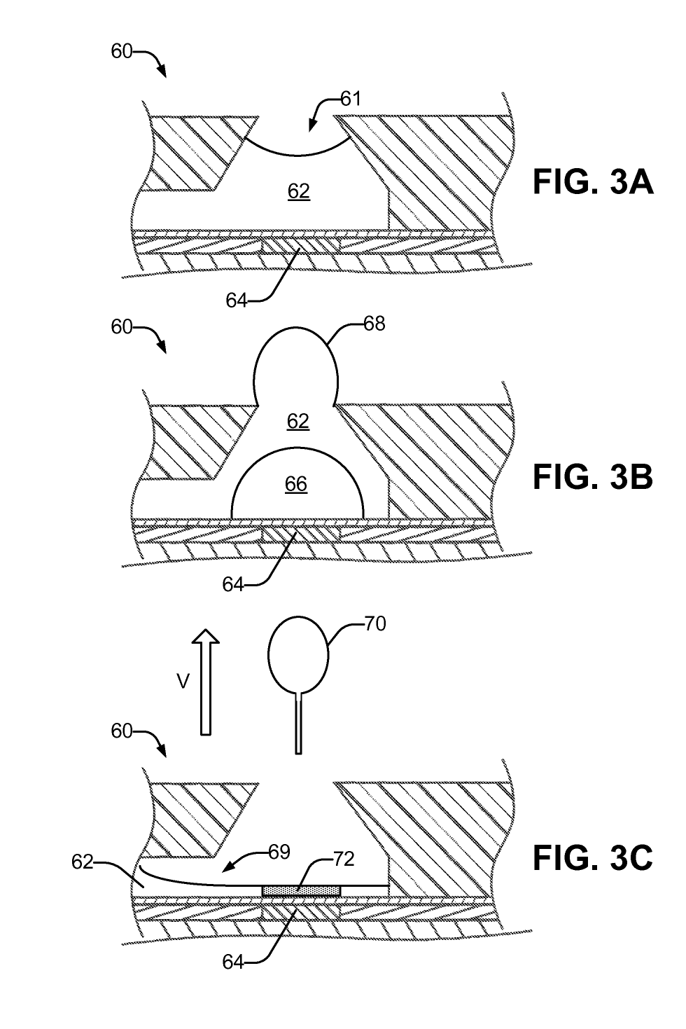

However, when using a thermal inkjet printhead to eject polymeric inks having lower values of Tg, the burst of heat from the firing resistor that forms a bubble in the liquid and causes a drop of liquid to be ejected from the printhead, also raises the temperature of the polymer phase above Tg. When the polymer phase then cools below Tg, as will be discussed subsequently in greater detail with reference to FIGS. 3A-C, a polymer residue or film can form, adhere to, and build up on the firing resistor. In some embodiments, the polymer residue is solidified. This residue or film can inhibit heat transfer from the firing resistor to the liquid on subsequent drop ejections. Diminished or inconsistent heat transfer from the resistor to the liquid typically results in ejected drops that deviate from desired drop characteristics, such as drop velocity, drop weight, drop-to-drop stability, and the like. Applying a second burst of heat from the firing resistor before the bubble collapses does not cause a second drop to be ejected but instead facilitates the removal of the polymer residue from the resistor. For example, the second burst of heat can reduce the total net residue on the surface of the firing resistor. In one embodiment, for example, the second burst of heat can reduce the adherence of the residue to the firing resistor surface. In this way, the resistor can be reconditioned to improve heat transfer from the firing resistor to the liquid on subsequent drop ejections, and thus maintain the desired drop characteristics on subsequently ejected drops.

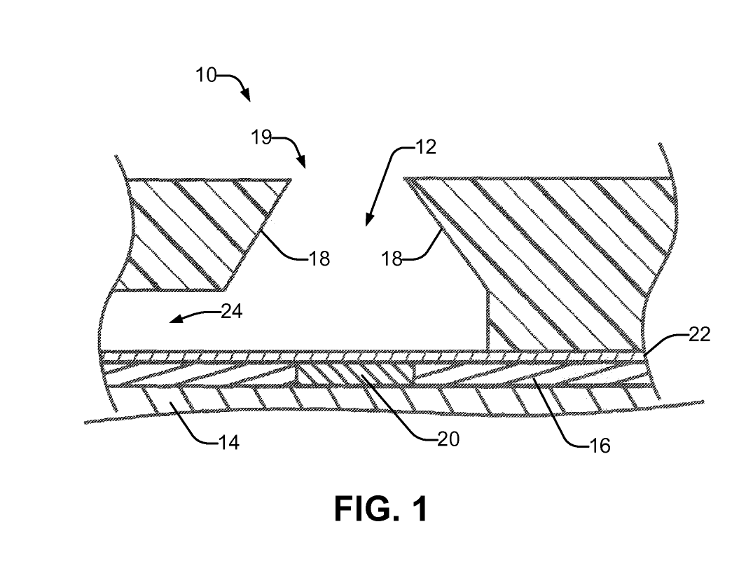

Considering now in further detail a liquid ejection element of an example thermal inkjet printhead in accordance with an embodiment of the present disclosure, and with further reference to FIG. 1, the liquid ejection element 10 has a firing chamber indicated generally at 12. Firing chamber 12 is formed on a suitable substrate 14, typically silicon. A firing resistor 20, formed from a layer of a resistive material deposited and patterned on substrate 14, is positioned at the bottom of firing chamber 12. The resistor 20 is typically rectangular in shape, having a surface area in a plane that is parallel to the bottom of the firing chamber 12. Firing chamber 12 also has a conductive layer 16 in electrical communication with firing resistor 20 for conducting current to the firing resistor. Conductive layer 16 and firing resistor 20 may, in some embodiments, be covered with one or more suitable passivation layers 22 which help protect the firing resistor 20. As defined herein and in the appended claims, a residue that is “on”, “adhered to”, “removed from”, etc., the firing resistor shall be broadly understood to mean “on”, “adhered to”, “removed from”, etc., either the firing resistor 20 or that portion of the passivation layer 22 that overlays or covers the firing resistor 20. Similarly, the “surface area of the firing resistor” shall be broadly understood to include both the surface area of the resistor 20 and the surface area of the passivation layer 22 that overlays or covers the firing resistor 20.

In one embodiment, the one or more suitable passivation layers 22 define the bottom surface of the firing chamber. The sides of firing chamber 12 are formed from one or more walls 18, depending upon the shape of the firing chamber. Walls 18 taper inwardly in some embodiments to form an orifice 19 through which liquid is ejected. A liquid delivery channel 24 is provided for delivering liquid to the firing chamber 12 to refill the firing chamber 12 after ejection of a drop of the liquid. In the depicted embodiment, orifice 19 is centered over firing resistor 20, as is common in many liquid ejection elements, although other configurations are contemplated.

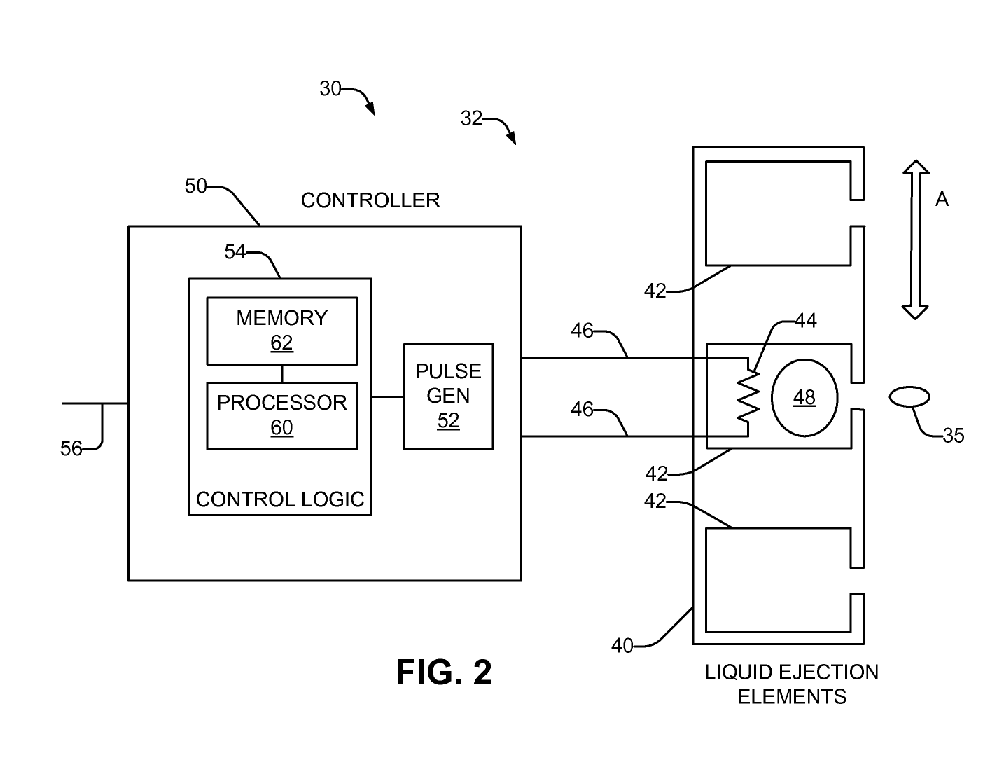

Considering now in further detail a thermal inkjet printer with a liquid ejection element and a controller that generates electrical pulses to the liquid ejection element in accordance with an embodiment of the present disclosure, and with further reference to FIG. 2, the printer 30 includes a set 40 of liquid ejection elements 42. The set 40 of liquid ejection elements 42 typically are disposed in a thermal inkjet printhead, indicated generally at 32, which typically is installable and replaceable in the printer 30. In some embodiments, a liquid ejection element 42 may be the liquid ejection element 10 of FIG. 1. Typically, the set 40 is arranged logically as a linear array of elements 42 each spaced a predetermined distance from each other along an axis A, although other geometries are also contemplated. In some embodiments the number of elements 42 in the printer 30 may be hundreds or thousands, and the spacing of adjacent elements 42 along axis A may range from 300 to 1200 or more elements per inch. Each element 42 has a firing resistor 44 (illustrated for one of the elements 42) through which electrical energy is controllably applied via conductors 46. Resistive heating effects heats liquid 48 adjacent in the element, and when sufficient heat is applied a drop 35 of the liquid is ejected from the element 42, as will be discussed subsequently in greater detail with reference to FIGS. 3A-C and 4.

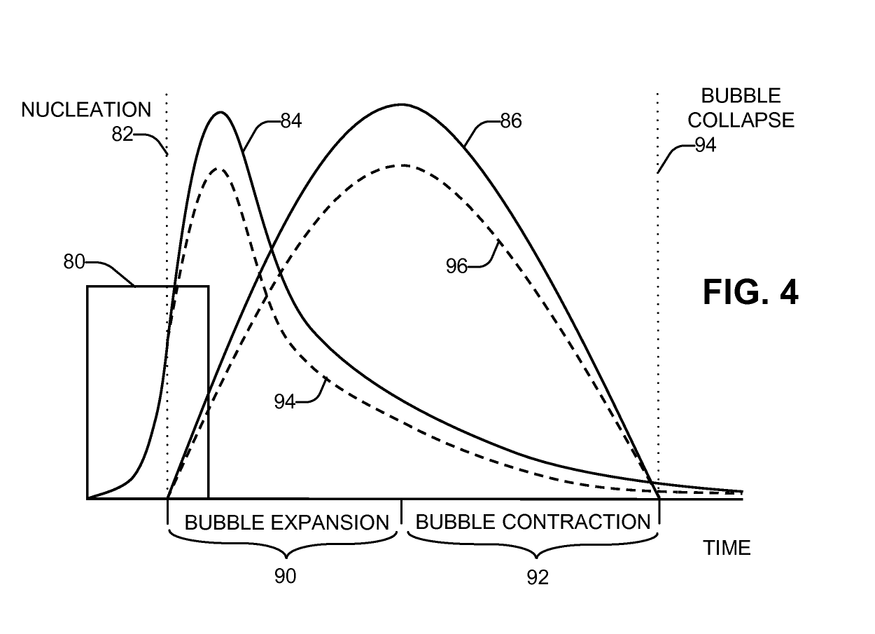

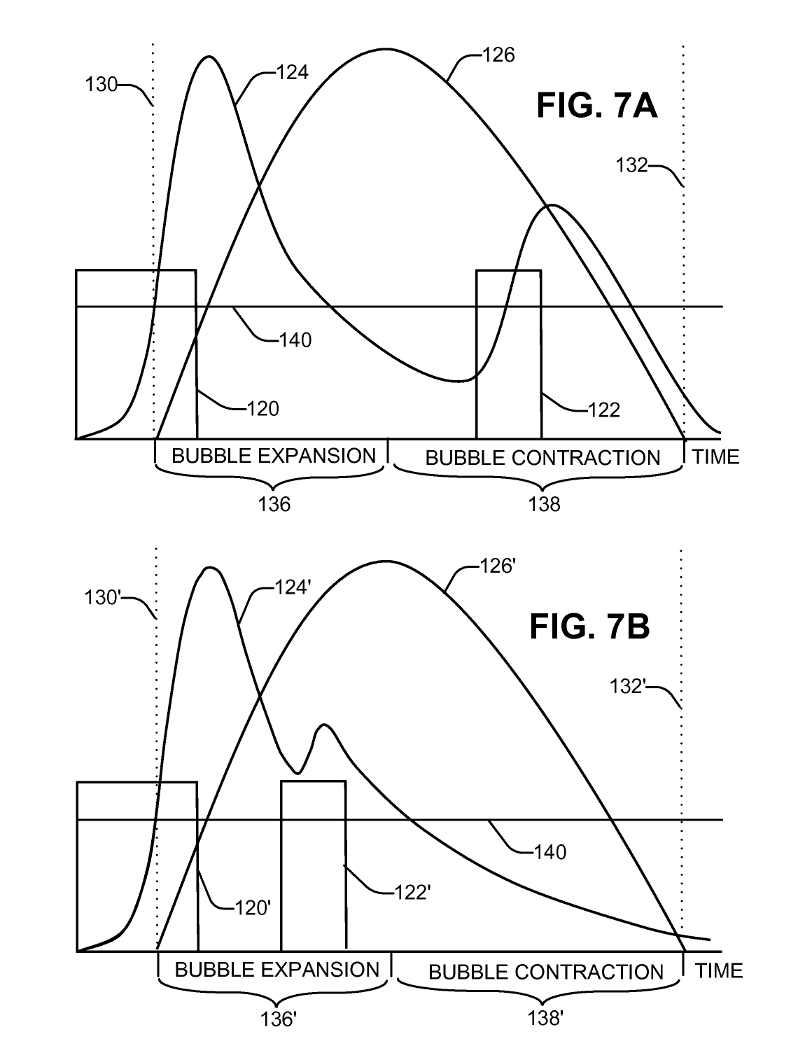

The conductors 46 are electrically coupled to a controller 50 which controllably applies the electrical energy to the firing resistor 44. The electrical energy is typically provided to the firing resistor 44 as one or more energy pulses. A pulse generator 52 provides energy pulses having an appropriate voltage for an appropriate duration of time (e.g. pulse width) to the firing resistor 44. The pulses are typically generated in accordance with print data or information regarding the desired printed output that is received by the controller via path 56. The energy pulses will be described subsequently in greater detail with reference to FIGS. 4 and 7A-B.

Operation of the pulse generator 52 is controlled by control logic 54. In some embodiments, part or all of the control logic 54 may be implemented in dedicated electrical hardware that may include, for example, discrete or integrated analog circuitry and digital circuitry such as, for example, programmable logic devices, application-specific integrated circuits, state machines, and the like. In some embodiments, part or all of the control logic 54 may be implemented in firmware or software that may define a sequence of logic operations and may be organized as instructions of modules, functions, or objects of a computer program. When the control logic 54 is implemented in firmware or software, the firmware or software can be stored on a computer-readable storage medium communicatively coupled to a processor. For example, in some embodiments control logic 54 may include memory 62 having programming code and data for implementing at least a portion of control logic 54 when executed by processor 60.

In some embodiments, part or all of the controller 50 may be fabricated as part of the printhead 32. In other embodiments, part or all of the controller 50 may be separate from, and electrically coupled to, the printhead 32. For example, part or all of the controller 50 may be disposed in the printer 30 separate from, and electrically coupled to, the printhead 32.

Considering now in further detail the ejection of a drop of liquid from a liquid ejection element in accordance with an embodiment of the present disclosure, and with further reference to FIGS. 3A-C, drop ejection results from the formation, expansion, contraction, and collapse of a thermally-generated bubble in the liquid. FIG. 3A schematically depicts liquid ejection element 60 in a preparatory state in which liquid 62 appropriately fills the firing chamber 61 in preparation for ejection. FIG. 3B schematically depicts the formation of an expanding bubble 66 of vaporized liquid which in turn drives a portion 68 of the liquid 62 out of the ejection element 60. The bubble 66 is formed by heating the firing resistor 64. The firing resistor 64 may be heated by applying an amount of electrical energy to the resistor 64 sufficient to eject a drop of the liquid 62. FIG. 3C schematically depicts the ejection of a drop 70 of the liquid 62 from the ejection element 60 and the collapse of the bubble 66. As the firing resistor 64 and the liquid 62 cool after heating is stopped, the bubble 66 contracts and a drop 70 is ejected. The drop 70 typically includes a tail, and exits the ejection element 60 with a velocity V. The contraction of the bubble 66 continues until the bubble 66 collapses. As has been described heretofore, the ejection of drops of certain latex and polyurethane liquids, such as those having a dispersed polymer phase and a Tg of about 70 or less, can form a polymer residue or film 72 on the surface of the firing resistor 64 as the heat raises the liquid temperature above Tg during the ejection process and then the remaining liquid is subsequently cooled. Following the collapse of the bubble 66, additional liquid 62 provided via liquid delivery channel 69 will refill the firing chamber 61, and the ejection element 60 returns to the condition illustrated in FIG. 3A.

The sequence of events depicted in FIGS. 3A-C occur quite rapidly. In some embodiments, a drop 70 is capable of being ejected from ejection element 60 about every 21 μs, or at a frequency of 48 kHz.

Considering now in further detail the bubble volume and temperature at the liquid-to-firing resistor interface of a liquid ejection element in response to the application of an ejection energy pulse to the firing resistor in accordance with an embodiment of the present disclosure, and with reference to FIG. 4, energy pulse 80 provides sufficient energy to the firing resistor to form a bubble to eject a drop of the liquid. As such, pulse 80 may be considered a “firing pulse”. This amount of energy may vary for different types of liquids. The energy pulse 80 causes the temperature 84 at the liquid-to-firing resistor interface to begin to increase, as the firing resistor heats up in response to the energy pulse 80. The temperature 84 is dependent at least in part on the efficiency of heat transfer from the firing resistor to the liquid. When the temperature reaches a certain level, a bubble begins to form at time 82, an event known as nucleation. While the pulse 80 continues to be applied after nucleation, the temperature 84 continues to increase rapidly, and the bubble volume 86 also rapidly increases. Then, after the pulse 80 is terminated, the temperature 84 begins to drop as the resistor cools. The bubble volume 86 continues to increase during bubble expansion phase 90, reaches a peak, and then the bubble volume begins to contract during bubble contraction phase 92. Drop separation may occur in some embodiments before bubble expansion is complete, or in other embodiments after bubble contraction has begun. The separated drop is ejected, and the bubble eventually collapses at time 94. This process occurs in an extremely short period of time. In some embodiments, the time from nucleation 82 to bubble collapse 94 may be between 1 μs and about 5 or more μs. In other embodiments, the time from nucleation 82 to bubble collapse 94 may be between 7 μs and 12 μs

When the liquid ejection element is used to eject drops of certain polymeric liquids, such as latex and polyurethane inks having a polymer phase dispersed in the solvent and a Tg below a certain value, polymer residue or film can form on the firing resistor, as has been explained heretofore with reference to FIG. 3C. The residue or film inhibits heat transfer from firing resistor to the liquid.

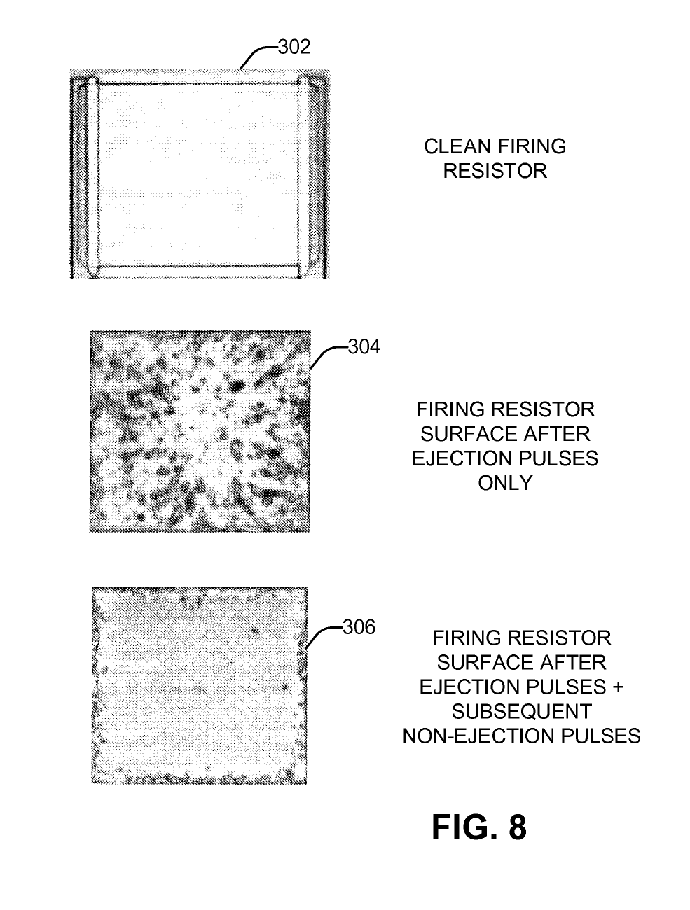

For example, consider that the pulse 80 described above was applied to a firing resistor having a clean (or relatively cleaner) surface area. In FIG. 8, firing resistor 302 is depicted with a clean surface, such as may exist in a printhead that has not previously been used. Following the ejection of drops of the polymeric liquid from the printhead, the residue builds up on the surface area of the firing resistor. This condition is illustrated by resistor 304 (FIG. 8), where the darker patches correspond to the residue and which, for example, are depicted as covering about 50% of the surface area. Typically, the more drops that have been ejected from an ejection element, the more residue builds up on the firing resistor surface, inhibiting heat transfer from the firing resistor to the liquid. As a result, when a subsequent firing pulse 80 is applied after additional residue has formed on the firing resistor, the temperature 94 at the liquid-to-residue interface can be lower than the temperature 84 associated with a prior pulse 80. Similarly, the bubble volume 96 of the subsequent pulse 80 may be smaller than the bubble volume 86 of the prior pulse 80. As a result, the drop of the liquid ejected as a result of the subsequent pulse 80 may not have the drop characteristics that are desired, or the same drop characteristics of the drop ejected by the prior pulse 80. For example, the drop velocity of the subsequent drop may be lower than that of the prior drop. Since in most printing systems there is relative movement between the print medium and the printhead during printing, a slower drop velocity can result in a dot being printed on the medium in an incorrect location, which degrades the image quality of the printed output. The drop volume, also known as drop weight, of subsequent drops may be less than that of prior drops due to the reduced heat transfer to the liquid. In other words, there is a lack of drop-to-drop stability or consistency when drops of polymeric liquid are ejected. The residue continues to build up on the resistor surface as additional pulses 80 are applied, and the drop characteristics deviate further from the desired ones as more residue is built up on the firing resistor. As a result, printheads get replaced much more frequently than is desired, due to the perceived degrading of the image quality of the printed output or due to failure of the firing resistor. The degradation may occur so rapidly that thermal inkjet ejection of the polymeric liquid may become impractical. For example, degradation may occur after ejection of about a thousand drops of polymeric liquid, compared to a typical range of hundreds of millions to billions of drops of another thermally inkjettable liquid, such as a non-polymeric liquid.

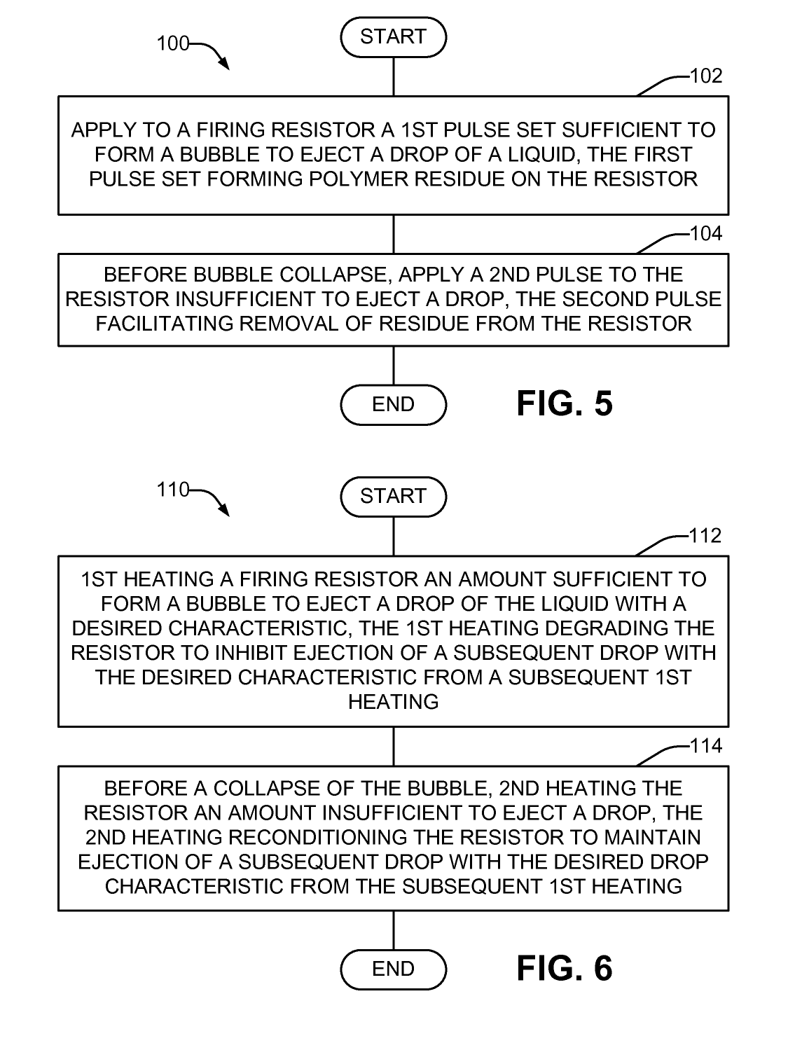

Removal of the residue can be facilitated, and the firing resistor reconditioned to maintain the desired drop characteristics of ejected drops, through methods of controllably ejecting liquid from a thermal inkjet printhead. Consider now, with reference to FIG. 5, a flowchart of a controller for controlling operation of one or more liquid ejection elements, such as, for example, controller 50 and ejection elements 42. Alternatively, the flowchart of FIG. 5 may be considered as steps in a method implemented in the controller. The flow or method 100 applies to a firing resistor, at 102, a first pulse set that is sufficient to form a bubble to eject a drop of a liquid having a polymer phase dispersed in a colloidal suspension. The first pulse set further forms a polymer residue on the firing resistor. In some embodiments, the residue is solidified on the firing resistor surface. At 104, after the first pulse set and before a collapse of the bubble, a second pulse insufficient to eject a drop of the liquid is applied to the firing resistor. The second pulse facilitates removal of at least a portion of the residue from the firing resistor.

The first pulse set includes at least one pulse. While FIG. 4 illustrates a single pulse 80 that causes nucleation to occur, in alternate embodiments a sequence of pulses may be used to cause nucleation. For example, consider a first pulse set having two pulses. The first pulse in the set is configured to not be sufficient to cause nucleation to occur, but is sufficient to preheat the fluid. Delaying for a period of time after the first pulse allows additional heat transfer from the resistor to the fluid to occur, which grows the boundary layer of the preheated fluid. Then the second pulse in the set is applied. Nucleation occurs during the second pulse, with the warm boundary layer resulting in a larger and more powerful drive bubble.

In addition, consider now, with reference to FIG. 6, a second flowchart of a controller for controlling operation of one or more liquid ejection elements, such as, for example, controller 50 and ejection elements 42. Alternatively, the second flowchart of FIG. 6 may be considered as steps in a method implemented in the controller. The flow or method 110 includes, at 112, first heating a firing resistor of the printhead an amount sufficient to form a bubble to eject a drop of the liquid having a desired drop characteristic, the first heating degrading the firing resistor so as to inhibit ejection of a subsequent drop with the desired drop characteristic from a subsequent first heating. As defined herein and in the appended claims, “first heating a firing resistor” shall be broadly understood to mean applying a first quantity of energy to the firing resistor over a first period of time during the process of ejection of a drop of the liquid to produce a first amount of heat at the firing resistor. The method 110 also includes, at 114, after the first heating and before a collapse of the bubble, second heating the firing resistor an amount insufficient to eject a drop of the liquid, the second heating reconditioning the firing resistor to maintain ejection of a subsequent drop with the desired drop characteristic from the subsequent first heating. As defined herein and in the appended claims, “second heating the firing resistor” shall be broadly understood to mean applying a second quantity of energy to the firing resistor over a second period of time during the process of ejection of the same drop of the liquid as the first heating to produce a second amount of heat at the firing resistor.

Considering now in further detail the bubble volume and temperature at the liquid-to-firing resistor interface of a liquid ejection element in response to the application of an ejection energy pulse and a subsequent non-ejection pulse to the firing resistor in accordance with an embodiment of the present disclosure, and with reference to FIGS. 7A-B, a first energy pulse set 120,120′ (illustrated as a single pulse) provides sufficient energy to the firing resistor to form a bubble 126,126′ to eject a drop of the liquid, in a similar manner as explained heretofore with reference to FIG. 4. The energy pulse set 120,120′ causes the temperature 124,124′ at the liquid-to-firing resistor interface to begin to increase, as the firing resistor heats up in response to the energy pulse set 120,120′. When the temperature reaches a certain level, a bubble begins to form at nucleation time 130,130′. While the pulse set 120,120′ continues to be applied after nucleation, the temperature 124,124′ continues to increase rapidly, and the bubble volume 126,126′ also rapidly increases. Then, after the pulse 120 is terminated, the temperature 124,124′ begins to drop as the resistor cools. Although the heat generated by the firing resistor in response to the energy provided by the pulse set 120,120′ is sufficient to eject a drop of the liquid, a second energy pulse 122,122′ is applied to the firing resistor after nucleation. In response to the second pulse 122,122′, the temperature 124,124′ once again increases as the resistor heats up again. Then, after the second pulse 122,122′ is terminated, the temperature 124,124′ begins to drop as the resistor cools again. During the application of the first pulse set 120,120′ and the second pulse 122,122′, the bubble volume 126,126′ increases during a bubble expansion phase 136,136′, reaches a peak, and contracts during bubble contraction phase 138,138′. The drop is ejected, and the bubble eventually collapses at time 132,132′. The time from nucleation 130,130′ to bubble collapse 132,132′ is substantially the same as has been described heretofore with reference to FIG. 4.

The second energy pulse 122,122′ is separate from the first energy pulse set 120,120′, and is applied at a time after the pulse set 120,120′ has terminated, but before the point of bubble collapse 132,132′. In one embodiment, as can be appreciated from FIG. 7A, the second pulse 122 is applied during the bubble contraction phase 138. In another embodiment, as can be appreciated from FIG. 7B, the second pulse 122′ is applied during the bubble expansion phase 136′.

The second energy pulse 122,122′ is insufficient to eject an additional drop of the liquid. In some embodiments, the insufficiency results from the timing of the second pulse 122,122′ with respect to the first pulse set 120,120′, to the bubble volume 126,126′, or both. For example, the lifecycle of the bubble volume 126,126′, from nucleation 130,130′ to collapse 132,132′, is directed to ejection of a single drop, and applying the second pulse 122,122′ when the ejection of the single drop is in progress inhibits the ejection of an additional drop. In order to eject a drop, the temperature 124,124′ is raised to a level above an ejection temperature 140, which is the minimum temperature utilized to eject a drop. In some embodiments, the ejection temperature 140 is at, or slightly below, the critical temperature of the liquid. However, even in embodiments in which the second pulse 122,122′ raises the temperature 124,124′ above the ejection temperature 140, an additional drop will not be ejected. For example, once nucleation occurs, there typically is little or no ink at the surface of the firing resistor until bubble collapse occurs, thus no ink can be ejected.

As has been explained heretofore with reference to FIGS. 3C and 4, the first pulse set 120,120′ can cause polymer residue or film to form on the firing resistor, which can inhibit heat transfer from the firing resistor to the liquid on subsequent first pulse sets 120,120′ for subsequent drop ejections. As a result, the firing resistor can be degraded such that subsequent drop ejections do not produce drops having desired drop characteristics, or having the same drop characteristics as earlier-ejected drops which were ejected before the buildup of the residue on the resistor. The second pulse 122,122′, however, reconditions the firing resistor by facilitating the removal of at least a portion of the residue from the firing resistor, such that subsequent drop ejections produce drops that have the desired drop characteristics, or the same or similar drop characteristics as do earlier-ejected drops.

For example, if a first pulse set 120,120′ for a drop ejection, or a series of first pulse sets 120,120′ for a series of drop ejections, were to be employed without second pulses 122,122′, polymer residue may build up on the surface area of the firing resistor, such as the darker patches of residue depicted on resistor 304 (FIG. 8). However, application of the second pulse 122,122′ facilitates the removal of at least a portion of the residue from the firing resistor, and results in a resistor surface area which has significantly less residue. For example, firing resistor 306 (FIG. 8) has significantly less adhered residue—in other words, fewer darker patches, covering significantly less of the surface area of the firing resistor—than does firing resistor 304. In some embodiments, less than about 20 percent of a surface area of the firing resistor is covered with the residue after residue removal occurs. Thus, when a subsequent first pulse set 120,120′ is applied, the temperature 124,124′ at the liquid-to-firing resistor interface will be substantially the same as for the prior first pulse set 120,120′. As a result, the drop that is subsequently ejected will have the same or similar drop characteristics, such as velocity, drop weight, and the like, as the previously ejected drop. This drop-to-drop consistency maintains high quality of the printed output. Furthermore, since residue is not being built up to any deleterious level on the surface area of the firing resistor, the lifetime of the printhead is significantly extended compared to operating conditions in which no second pulse 122,122′ is applied. Moreover, because the second pulse 122,122′ is applied to the firing resistor during the bubble lifecycle associated with a drop ejection, rather than during a period separate from and in addition to the bubble lifecycle, the second pulse 122,122′ does not result in any significant reduction of printing throughput for the printing device or printhead. As defined herein and in the appended claims, “bubble lifecycle” shall be broadly understood to mean the time between nucleation (such as, for example, nucleation 130 of FIG. 7A) and bubble collapse (such as, for example, bubble collapse 132 of FIG. 7A).

In some embodiments, the second pulse 122,122′ may facilitate the removal of at least a portion of the residue from the firing resistor by reducing adherence of the residue to the firing resistor. Adherence may be reduced by the increase in the temperature 124,124′ caused by the second pulse 122,122′ melting the portion of the built-up residue that contacts the surface area of the firing resistor; forming a gaseous or less-adhesive char layer at the residue-to-firing resistor interface; or by other effects. In some embodiments, at least a portion of the residue may be removed by the second pulse 122,122′ itself. In some embodiments, at least a portion of the residue may be removed by the inflow of fluid through the liquid delivery channel 24 (FIG. 1) to refill the firing chamber 12 (FIG. 1) after ejection of a drop of the liquid. In some embodiments, at least a portion of the residue may be removed by a subsequent first pulse set 120,120′ for the ejection of a subsequent drop of the liquid.

In some embodiments, a second pulse 122,122′ may follow each first pulse set 120,120′, or most first pulse sets 120,120′. In other embodiments, a second pulse 122,122′ may be applied after a plurality of first pulse sets 120,120′ have been applied. One or more second pulses 122,122′ may be applied periodically, such as after every N first pulse sets 120,120′. One or more second pulses 122,122′ may be applied if a degradation in drop characteristics, or a degradation in the quality of a printed image, is detected, either by the printing device or by a user. One or more second pulses 122,122′ may be applied after the printhead has printed a swath of the print medium, in some embodiments as part of a servicing operation in which one or more drops are ejected on an unused portion of the print medium or into a service station.

The characteristics of the first ejection pulse set 120,120′ and the second non-ejection pulse 122,122′ may depend on the particular composition of the fluid to be ejected, the architectural characteristics of the printhead and ink ejection elements, or both. The second non-ejection pulse 122,122′ delivers less energy than does the first ejection pulse set 120,120′. In some embodiments, the voltage of the second pulse 122,122′ and the voltage of at least some of the pulses in the first pulse set 120,120′ are substantially the same. In some embodiments where the first pulse set 120,120′ is a single ejection pulse, the width of the second non-ejection pulse 122,122′ is less than the width of the ejection pulse 120,120′.

In some embodiments, a test setup in which surface cleanliness of the firing resistor can be observed may be used to determine the appropriate pulse characteristics. Optimal values for pulse characteristics such as the number of pulses in the first pulse set 120,120′, the voltage and width of the individual pulses in the first pulse set 120,120′ and the second pulse 122,122′, and the energy per unit of surface area of the firing resistor delivered by these pulses can be varied, and the fraction of the surface covered by the residue in response to the varied pulse characteristics observed, in order to determine the optimal values that result in good resistor surface cleanliness. In another embodiment, a test setup capable of measuring drop velocity and/or other characteristics of drops emitted from the printhead may be used to determine the particular pulse characteristics which produce the highest and/or most consistent drop characteristics. In some embodiments, characterizing the pulses in terms of energy per unit area may allow optimal pulses for a particular ink type determined for an ink ejection element having a given resistor geometry to be readily translated into optimal pulses for the particular ink type for another ink ejection element having a different resistor geometry.

From the foregoing it will be appreciated that the printhead and methods provided by the present disclosure represent a significant advance in the art. Although several specific embodiments have been described and illustrated, the disclosure is not limited to the specific methods, forms, or arrangements of parts so described and illustrated. For example, embodiments of the disclosure are not limited to ejecting fluids for printing purposes, but may be used in conjunction with ejecting fluids for other purposes. This description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Terms of orientation and relative position (such as “top,” “bottom,” “side,” and the like) are not intended to require a particular orientation of any element or assembly, and are used for convenience of illustration and description. Unless otherwise specified, steps of a method claim need not be performed in the order specified. The disclosure is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements.

What is claimed is:

1. A method of controllably ejecting liquid from a thermal inkjet printhead, comprising:
applying to a firing resistor a first pulse set sufficient to form a bubble to eject a drop of a liquid having a polymer phase dispersed in a colloidal suspension, the first pulse set further forming a polymer residue on the firing resistor; and
applying, after the first pulse set and before a collapse of the bubble, a second pulse to the firing resistor insufficient to eject a drop of the liquid, the second pulse facilitating removal of at least a portion of the residue from the firing resistor.

2. The method of claim 1, wherein the polymer residue degrades the firing resistor so as to inhibit a subsequent first pulse set from ejecting a subsequent drop with a desired drop characteristic, and wherein the second pulse reconditions the firing resistor to enable the subsequent first pulse set to eject a subsequent drop with the desired drop characteristic.

3. The method of claim 1, wherein the polymer phase has a glass transition temperature less than 70 degrees C., and wherein the first pulse set heats the liquid above the glass transition temperature.

4. The method of claim 1, wherein the colloidal suspension includes particles between 50 and 500 nanometers in diameter.

5. The method of claim 1, wherein the residue is a polymer film adhered to the firing resistor.

6. The method of claim 1, wherein the second pulse reduces adherence of the residue to the firing resistor.

7. The method of claim 1, wherein the second pulse is applied before bubble contraction begins.

8. The method of claim 1, wherein less than about 20 percent of a surface area of the firing resistor is covered with the residue after the removal.

9. The method of claim 1, wherein the first pulse set and second pulse heat the liquid above an ejection temperature.

10. The method of claim 1, wherein the second pulse is applied after a plurality of the first pulse sets.

11. A method of controllably ejecting liquid from a thermal inkjet printhead, comprising:
first heating a firing resistor of the printhead an amount sufficient to form a bubble to eject a drop of the liquid having a desired drop characteristic, the first heating degrading the firing resistor so as to inhibit ejection of a subsequent drop with the desired drop characteristic from a subsequent first heating; and
after the first heating and before a collapse of the bubble, second heating the firing resistor an amount insufficient to eject a drop of the liquid, the second heating reconditioning the firing resistor to maintain ejection of a subsequent drop with the desired drop characteristic from the subsequent first heating.

12. The method of claim 11, wherein the liquid has a polymer phase dispersed in a colloidal suspension, wherein the firing resistor is degraded by a polymer residue formed on the firing resistor by the first heating, and wherein removal from the firing resistor of at least a portion of the residue is facilitated by the second heating.

13. The method of claim 11, wherein the drop characteristic includes a drop velocity.

14. The method of claim 11, wherein the first heating includes applying a first energy pulse set to the firing resistor and the second heating includes applying a second energy pulse to the firing resistor, wherein the second energy pulse is applied after a plurality of the first energy pulse sets.

15. The method of claim 11, wherein the first heating includes applying a first energy pulse set to the firing resistor and the second heating includes applying a second energy pulse to the firing resistor, wherein the first energy pulse set is applied a plurality of times to print a swath, and wherein the second energy pulse is applied after the swath is printed.

16. The method of claim 11, wherein the first heating includes applying a first energy pulse set to the firing resistor and the second heating includes applying a second energy pulse to the firing resistor, and wherein the second energy pulse is applied when a deviation from the desired drop characteristic is detected.

17. The method of claim 1, wherein the first pulse set comprises at least one pulse.

18. A thermal inkjet printer comprising:
a firing resistor configured to receive electrical pulses from a controller, the controller configured to
apply to the firing resistor a series of first pulse sets, each first pulse set sufficient to form a bubble to eject from the printer a drop of a liquid having a polymer phase dispersed in a colloidal suspension, the series of first pulse sets forming a polymer residue on the firing resistor, and to
apply, after at least one of the first pulse sets and before a collapse of the bubble associated therewith, a second pulse to the firing resistor insufficient to emit a drop of the liquid, the second pulse facilitating removal of at least a portion of the residue from the firing resistor.

19. The printer of claim 18, wherein the residue is a polymer film adhered to the firing resistor, and wherein the second pulse reduces adherence of the residue to the firing resistor.

20. The printer of claim 18, wherein less than about 20 percent of a surface area of the firing resistor is covered with the residue after the removal.
